(19) United States
(12) Patent Application Publication
(10) Pub. No.: US 2023/0018453 A1
(43) Pub. Date: Jan. 19, 2023

(54) High Temperature Grill Assembly for Searing Food

(71) Applicant: Mark David Crandon, Redwood City, CA (US)

(72) Inventor: Mark David Crandon, Redwood City, CA (US)

(21) Appl. No.: 17/662,395

(22) Filed: May 6, 2022

Related U.S. Application Data
(60) Provisional application No. 63/223,515, filed on Jul. 19, 2021.

(51) Int. Cl. A47J 37/07

(52) U.S. Cl. CPC A47J 37/079; A47J 37/0704

(57) ABSTRACT

The present invention is a high temperature grill assembly with an integrated grill top, griddle top, coal box, base tray assembly and burner tube assembly that integrated together is an apparatus that generates extreme high temperatures for cooking and searing food by burning charcoal briquettes and using a high-volume airflow up draft through the coal box.

This application claims priority of US Provisional Patent Application number (63/223,515), which is hereby incorporated by reference.

### BACKGROUND OF THE INVENTION

The present invention is in the field of outdoor cooking grills. More particularly the present invention is in the field of a specialty outdoor cooking High Temperature Grill Assembly for specifically used to sear the exterior surface of a meat product.

Conventional gas and charcoal grills use a traditional oval or square shape and serve as a general-purpose cooking appliance. Their ability to generate the intense heat is limited by the fuel capacity, the intake of air to fuel combustion and the ability to direct this heat towards the food to be seared. Additionally, existing gas or charcoal grills utilize a spacious area to accommodate a broad arrangement of food products thus limiting the capacity of the device to generate the 800-degree Fahrenheit intense heat capable of searing food with an optimum sear. Existing charcoal grill accessories are not capable of acting as high temperature grills for searing because due to the fact they a) lack a grill top, b) lack the ability to place a grill top safely, c) lack a griddle top that enables continuous airflow to maintain the heat generation, d) lack a base to hold the hot ashes and protect the surface below from damage, e) lack safety devices to easily move the entire appliance from place to place, f) do not provide the proper aspect ratio for cooking a variety of foods such as large steaks, roasts, porterhouse steaks, full prime rib steaks and more.

### SUMMARY OF THE INVENTION

The present invention is a dedicated food high temperature searing grill that provides an ability to create an intense heat source, direct that heat source towards the meat/food to be seared, provide an integrated grill that is securely seated in the product for safety and security, provide an integrated basin to protect the sub-surface and collect the ashes from the solid fuel, provide heat safe handles throughout the components to allow for safe and secure transportation and provide an integrated flat and serrated griddle that is securely seated in the product for safety and security.

The present invention may exist as a charcoal grill assembly with a base assembly, solid fuel briquettes configured within the base assembly, and a coal box configured within the base assembly such that some of the fuel briquettes are configured within the coal box. The fuel briquettes may be ignited to generate heat, that may rise to the top of the coal box to cook food configured on top of the coal box.

The coal box may be rectangular with four side walls. The four side walls may exist as four separate pieces that are configured together to form the coal box. Alternatively, the first a second side wall may be permanently configured together as a first formed sheet. A third and fourth side wall may be permanently configured together as a second formed sheet. The two formed sheets may be configured together to form the coal box. Each of the two formed sheets may have a tab that is configured against the other formed sheet. The formed sheets may then be mated together by use of welding and/or press brakes. The four side walls may be configured so that the rectangular shape of the coal box is open at the top and bottom.

Vent holes may be configured on each of the four side walls of the coal box. The vent holes may be open/closed to control the amount of air to enter the coal box so that the charcoal grill assembly does not transfer too much heat to the food. Vent holes may be configured on each of the four side walls of the coal box. The vent holes may allow ambient air to enter the coal box so that the ambient air is heated, which then rises through the coal box and transfers heat to the food. The coal box may have a top half and a bottom half separated by a midline axis. The vent holes may be configured on the top half of the coal box. The vent holes may be configured on the bottom half of the coal box.

A coal box handle may extend from one of the four side walls. The coal box handle may alternatively extend from a junction between two of the four side walls. The goal box handle may have a coal box handle grip. The coal box handle grip may be a metal spring, or a series of metal wires configured around the coal box handle. The coal box handle grip may have two tapered ends that are each connected to the coal box handle. The coal box handle grip may allow a user to easily grip the coal box handle. The coal box handle grip may further protect a user's hand from the heat generated by the coal box assembly by serving as a barrier between the coal box handle and the user's hand.

Two notches may be configured on each of two of the four side walls of the coal box, such that the coal box has a total of four notches on two of the four side walls. Each notch may be U-shaped. The notches may be configured at the portions of the side walls that form the top of the coal box. The two side walls that have the notches may be side walls configured opposite to one another such that two of the four notches are configured opposite the other two of the four notches.

The base assembly may have a bottom surface that is configured perpendicular to the four side walls of the coal box when the coal box is configured within the base assembly. The base assembly may further have four side surfaces that extend from the base assembly. The four side surfaces may be angled outwards from the bottom surface such that they are not perpendicular to the bottom surface nor the four side walls of the coal box. Each of the four side surfaces of the base assembly may form at least a 30-degree angle with the bottom surface. Each of the four side surfaces may further form at least a 45-degree angle with the base assembly.

Four legs may extend downwards from the bottom surface of the base assembly. Each of the four legs may be perpendicular to the bottom surface. Alternatively, each of the four legs may extend from the bottom surface at an angle such that the four legs are not perpendicular to the bottom surface. A base assembly handle may extend from each of two of the four side surfaces such that a total of two base assembly handles extend from two of the four side surfaces. Each base assembly handle may have a base assembly handle grip. Each base assembly handle grip may be of similar design and construction to the coal box handle grip.

A grill top may be constructed from a plurality of metal rods. The metal rods may be cylindrical. Alternatively, the metal rods may be rectangular prisms. Longer metal rods may be configured parallel to one another, and may serve as a grilling surface on which to place food. Shorter metal rods may be configured perpendicular to the longer metal rods, and may serve as supports onto which the longer metal rods are configured. Two grilling top handles may extend from the grill top such that one grilling top handle each extends from an opposite side of the grill top. Each grilling top handle may be formed by extensions from the metal rods of the grill top. A grilling top handle grip may be configured on each of the grill top handles. The grilling top handle grips may be of similar design and construction to the coal box handle grip.

A griddle top may be constructed from one or more cast iron sheets. Two griddle top handles may extend from the griddle top such that one griddle top handle each extends form an opposite side of the griddle top. Each griddle top handle may be attached to the griddle top by either welding the griddle top handles to one of the cast iron sheets or casting the griddle top handles to the cast iron sheets. A griddle top handle grip may be configured on each of the griddle top handles. The griddle top handle grips may be of similar design and construction to the coal box handle grip. The griddle top may have a flat surface wherein the surface of the cast iron sheet is smooth. Opposite the flat surface may be a ridged surface wherein protrusions may extend from the cast iron sheet.

The grill top and griddle top may be interchangeably configured on top of the coal box by placing the grilling top handles or griddle top handles within the notches of the coal box. When the solid fuel briquettes are ignited, they may burn to generate heat, which travels up through the coal box. The heat may reach the grill top or griddle top, and may be conducted to food placed on top of the grill top or griddle top to cook the food.

An internal grate may be configured within the base assembly and within the coal box. The solid fuel briquettes may be configured on top of the metal grate. The internal grate may serve to create an airspace below the solid fuel briquettes so that air can reach the solid fuel briquettes to be heated. When burning, the solid fuel briquettes may create ash. The ash may fall through the internal grate and may be collected within the base assembly.

A burner tube may be connected to the coal box by a circular flange at one end of the burner tube. The burner tube may be an angled, hollow, metal tube. The end of the burner tube that does not have the circular flange may have a threaded coupling. The threaded coupling may attach to a gas fuel source. The gas fuel source may be any container that contains a flammable gas. The gas fuel source may be but is not limited to a portable propane container, a non-portable propane container, a portable natural gas container, a non-portable natural gas container, a propane line, or a natural gas line. Burner tube holes may be configured along the burner tube to provide an even flame to the solid fuel briquettes. The burner tube holes may be configured along a length of an angled section of tube. A tube cap may be fitted on the angled section of tube to seal the burner tube. The threaded coupling may be configured on a portion of the burner tube that is not the angled section of tube (“the non-angled section of tube”).

The burner tube may be connected to the coal box such that the burner tube is configured below the solid fuel briquettes. The burner tube may use the gas fuel source to ignite the solid fuel briquettes so that the solid fuel briquettes burn to generate heat. Ambient air from the vent holes may enter the coal box below the solid fuel briquettes. The ambient air may then be heated by the burning fuel briquettes and rise through the coal box due to the chimney affect. Some of the heated air may escape through the vent holes so that the amount of heat transferred to the food is regulated. The remaining hot air may reach the grill top or griddle top and may heat the grill top or griddle top. The grill top or griddle top may transfer said heat to food placed on top of the grill top or griddle top through conduction, thereby cooking the food.

The solid fuel briquettes may be any solid objects that are able to be burned. In preferred embodiments of the invention, the solid fuel briquettes are charcoal briquettes. In other embodiments, the solid fuel briquettes may be pieces of wood, cardboard, plywood, or commercial fire starter comprising sawdust and wax.

### BRIEF DESCRIPTION OF DRAWINGS

FIG. 1—Isometric, Assembly View of the High Temperature Grill Assembly (also referred to as a “charcoal grill assembly”) components including the Grill Top (1.1), Griddle Top (1.6), Coal Box (1.3) and components (handle), Base Assembly (1.4) and components (handles), Legs (1.7) and Burner Tube (1.5) Assembly.

FIG. 2—Isometric View of Assembled High Temperature Grill Assembly with Grill Top from the Handle Side. (All components of the invention in an assembled view of Invention in FIG. 1 from the rear side)

FIG. 3—Isometric View of Assembled High Temperature Grill Assembly of Handle Side with Grill Top (All components of the invention in an assembled view of Invention in FIG. 1 from the front side)

FIG. 4—Cross Section View of Assembled High Temperature Grill Assembly with Grill Top. (Invention cross section of FIG. 3)

FIG. 5—Top View of Assembled High Temperature Grill Assembly with Griddle Top

FIG. 6—Side View of Assembled High Temperature Grill Assembly with Grill Top

FIG. 7—Front/Handle View of Assembled High Temperature Grill Assembly with Grill Top

FIG. 8—Isometric View of the Assembled View of the High Temperature Grill Assembly with the Griddle Top (All components of the invention in assembly view with the Griddle Top in view)

FIG. 9—Isometric of High Temperature Grill Assembly with the Griddle Top on top of Coal Box (All components of the invention in an assembled view of Invention in FIG. 8 from the rear side with the Griddle Top.)

FIG. 10—Isometric View of High Temperature Grill Assembly Coal Box Component

FIG. 11—Isometric View of High Temperature Grill Assembly Base Assembly Component

FIG. 12—Isometric View of High Temperature Grill Assembly Grill Top Component

FIG. 13—Isometric View of Top Side of High Temperature Grill Assembly Griddle Top Component

FIG. 14—Isometric View of Bottom Side of High Temperature Grill Assembly Griddle Top Component

FIG. 15—Isometric View of High Temperature Grill Assembly Coal Box Component as it will be manufactured and assembled (assembly view of Coal Box Component from FIG. 10)

FIG. 16—Top View of Assembled High Temperature Grill Assembly with Griddle Top

FIG. 17—Isometric view of Burner Tube Assembly

### DETAILED DESCRIPTION OF THE INVENTION

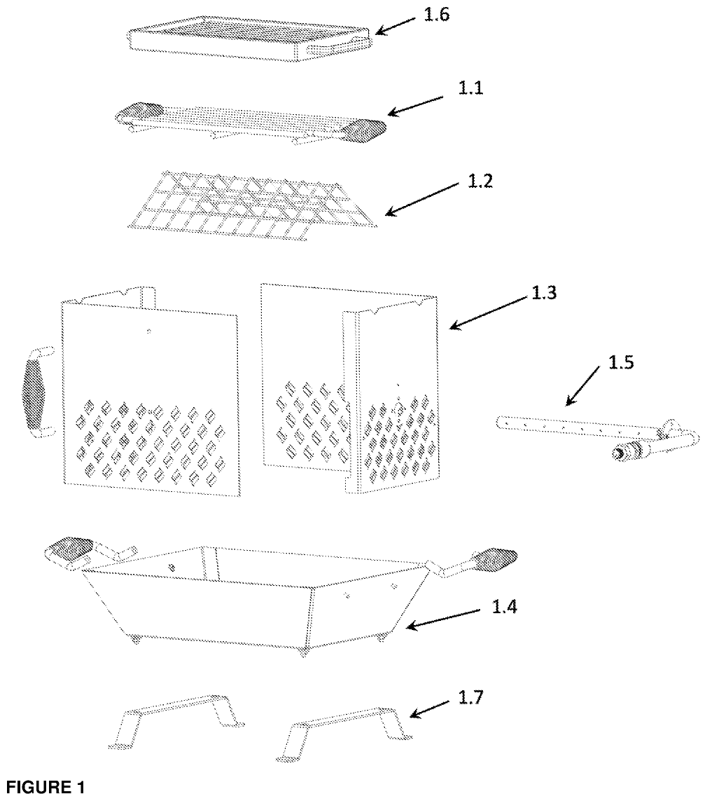

Referring now to the invention in more detail, in FIG. 1 there is shown the major components in an assembly view. The invention components are identified as the following:

FIG. 1, invention Component 1.1: this is the High Temperature Grill Assembly Grill Top (“Grill Top”). This is the surface that food is placed upon to sear. Construction details of the Grill Top are that it will be manufactured from a steel product to provide strength, longevity, and weather resistance. The handles on the Grill Top provides a cool surface to lift the Grill Top as required.

FIG. 1, invention Component 1.2: this is the High Temperature Grill Assembly Internal Grate (“Internal Grate”). This is where solid fuel product (“charcoal”) is placed which is ignited to generate the heat source for searing the food. The Internal Grate will be manufactured from a steel product that provides strength, heat resistance and weather resistance.

FIG. 1, invention Component 1.3: this is the High Temperature Grill Coal Box (“Coal Box”). This provides the containment for the charcoal and a structure to hold the Internal Grate (1.2) and the structure to hold the Grill Top (1.1). The High Temperature Grill Assembly Coal Box is unique in that it has a design utilizing holes along the bottom half that provide a chimney effect for the solid fuel producing intense heat to sear the food. The Coal Box will be manufactured from a steel product that provides strength, heat resistance and weather resistance

FIG. 1, invention Component 1.4: this is the High Temperature Grill Assembly Base (“Base Assembly”). This unique design provides multiple functions: a) a base to catch the ashes from the solid fuel, b) a base to protect the subsurface from the heat created from the burning solid fuel in the Coal Box (1.3), and c) handles that allow the user to transport the entire High Temperature Grill Assembly safely and easily. The Base Assembly has legs (1.7) that are attached via machine screws and provide a stable platform for safety and security. The Base Assembly will be manufactured from a steel product that provides strength, heat resistance and weather resistance.

FIG. 1, invention Component 1.6: this is the High Temperature Grill Assembly Griddle Top (“Griddle Top”) providing a solid, flat and edged surface that food is placed upon to sear. This surface is a solid surface preventing delicate food from falling in the Coal Box. Construction details of the Griddle Top are that it will be manufactured from cast iron to provide heat retention, strength, longevity, and weather resistance. The handles on the Griddle Top provides a mechanism to handle the Griddle Top but also a mechanism to securely affix the Griddle Top to the Coal Box.

FIG. 1, invention Component 1.5: this is the High Temperature Grill Assembly Burner Tube (“Burner Tube”). The Burner Tube attaches to the Coal Box using machine screws. The exposed end of the burner tube has a threaded attachment for connecting to a standard propane fuel tank. Propane can be piped through the burner tube, and ignited providing a simple, easy to use mechanism for lighting the charcoal.

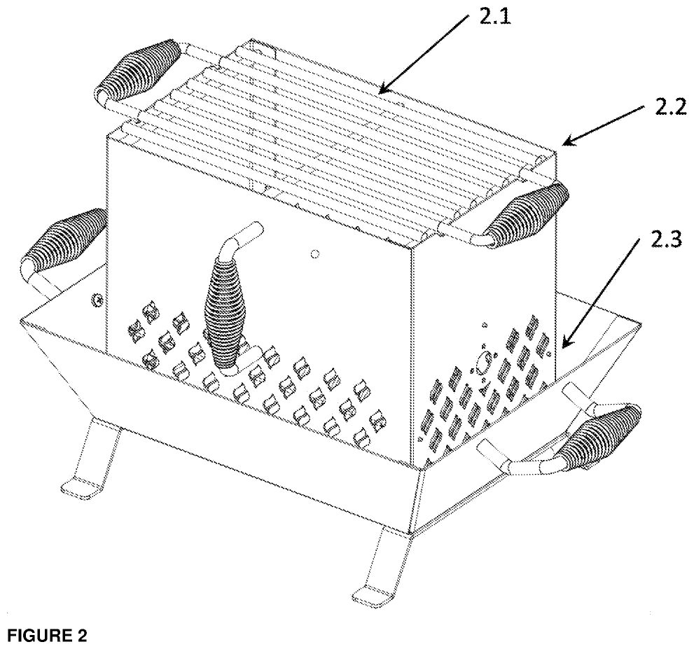

FIG. 2 of the invention shows all the components from FIG. 1 in an assembled view from the back side of the High Temperature Grill Assembly. 2.1 demonstrates how the Grill Top is removable but situated inside the top of the Coal Box in notches that are identified by 2.2. The notches are such that the handle of the Grill Top prevents the grill from sliding off the Coal Box and presenting a safety problem. A fully assembled High Temperature Grill Assembly, the Coal Box is designed to sit inside the Base Assembly as shown by 2.3 in a way that keeps the Coal Box from excessive movement thus providing safety and security.

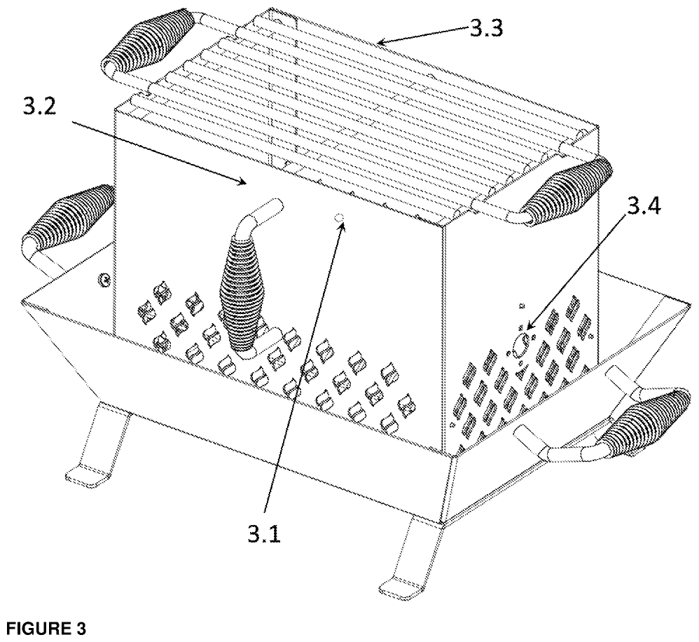

FIG. 3 of the invention shows all the components from FIG. 1 in an assembled view but from the front side of the High Temperature Grill Assembly. The Coal Box provides a mechanism (3.1) where a thermometer can be inserted allowing the user to fine tune the temperature for specific user needs. The Coal Box has a screwed-on Coal Box Handle (3.2) that allows the user to easily lift the Coal Box to insert fuel in the bottom of the Coal Box and to easily clean the components. The Coal Box has a mechanism (3.4) for securely and safely attaching the Burner Tube.

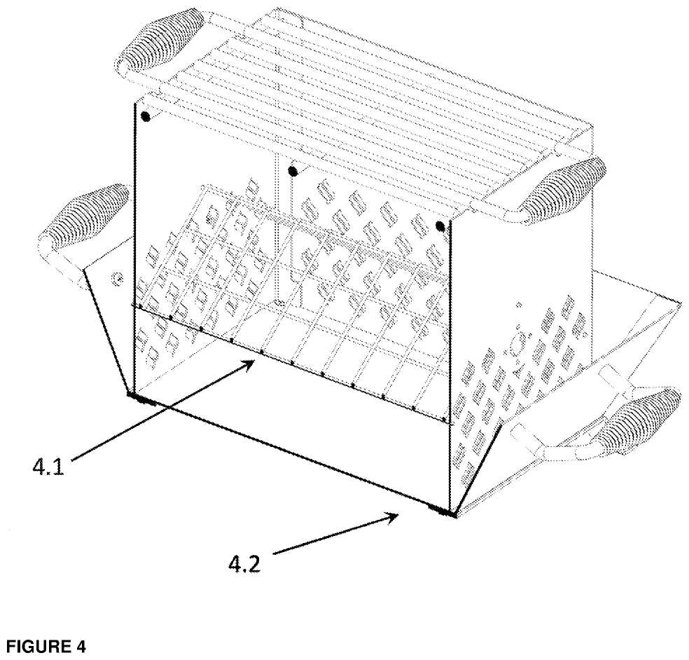

FIG. 4 of the invention is a cross section view of the assembled High Temperature Grill Assembly. 4.1 shows the Internal Grate securely seated inside the Coal Box by extending support structures through the walls of the Coal Box. 4.2 shows that the Coal Box and Base Assembly are designed such that the Coal Box seats in the Base Assembly securely and safely.

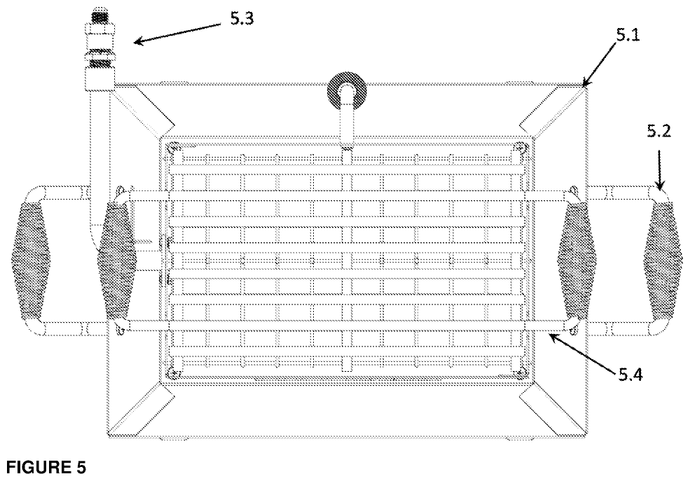

FIG. 5 of the invention is a Top View of the assembled High Temperature Grill Assembly with the Grill Top. The Grill Top Handles (5.4) and the Base Assembly Handles (5.2) are designed to be attractive and not interfering with one another. The corners of the Base Assembly (5.1) are designed for easy manufacturing in common press brakes. The Burner Tube (5.3) extends from one end inside the Coal Box to the other end of the Coal Box and then outside for a short distance for safety away from the coal box. The exterior connector for the propane fuel tank source is outside the heat zone of the coal box.

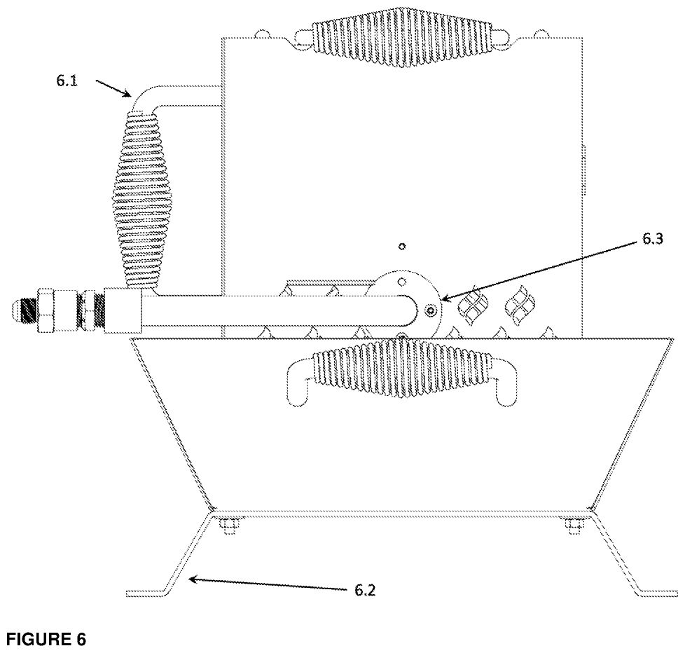

FIG. 6 of the invention is a side view of the High Temperature Grill Assembly with the attached Grill Top. The Coal Box Handle (6.1) is attached with machine screws and designed to clear the top of the base. The Legs (6.2) are attached to the Base Assembly and extend at an outwards angle to provide stability to the entire High Temperature Grill Assembly for safety and security. The Coal Box has a unique ability to insert the Burner Tube in the device (6.3) to ignite the charcoal that is on top of the Internal Grate. The Burner Tube attaches to the Coal Box via a circular flange that is affixed to the Burner Tube.

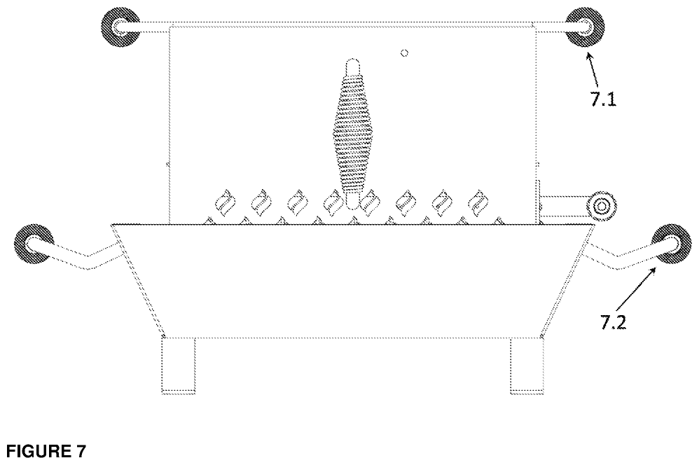

FIG. 7 of the invention is a side view of the Assembled High Temperature Grill Assembly with attached Grill Top. The Grilling Top Handles of the Grill Top (7.1) extend through the notches on the top edge of the Coal Box while the metal rods of the Grill Top are securely located inside the walls of the Coal Box. The Base Assembly Handles (7.2) are angled to attach to the Base at a perpendicular angle and then provide an aesthetic and easy to hold angle for the user.

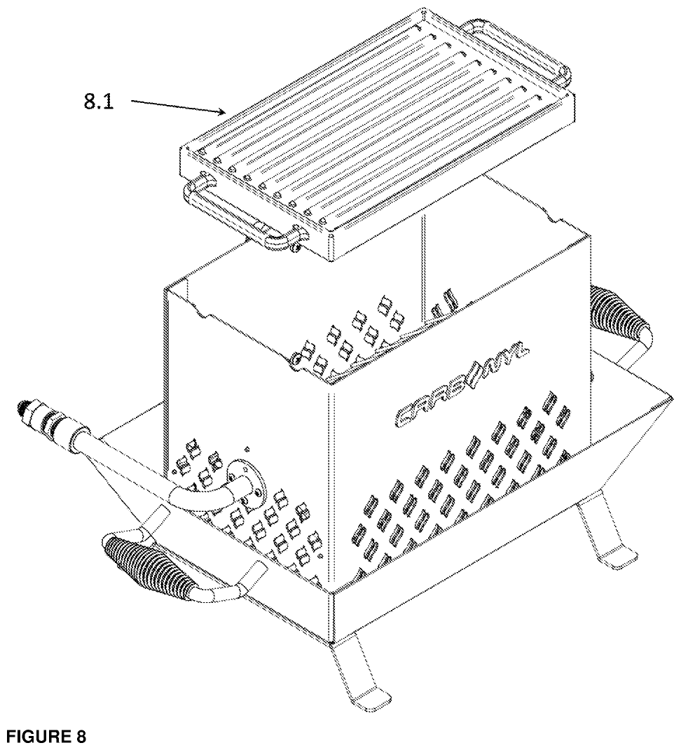

FIG. 8 of the invention is an isometric view of the Assembly of the High Temperature Grill Assembly with the Griddle Top (8.1) in place instead of the Grill Top. The Griddle Top is interchangeable with the Grill Top. The Griddle Top is also reversible with a flat side and an edged side.

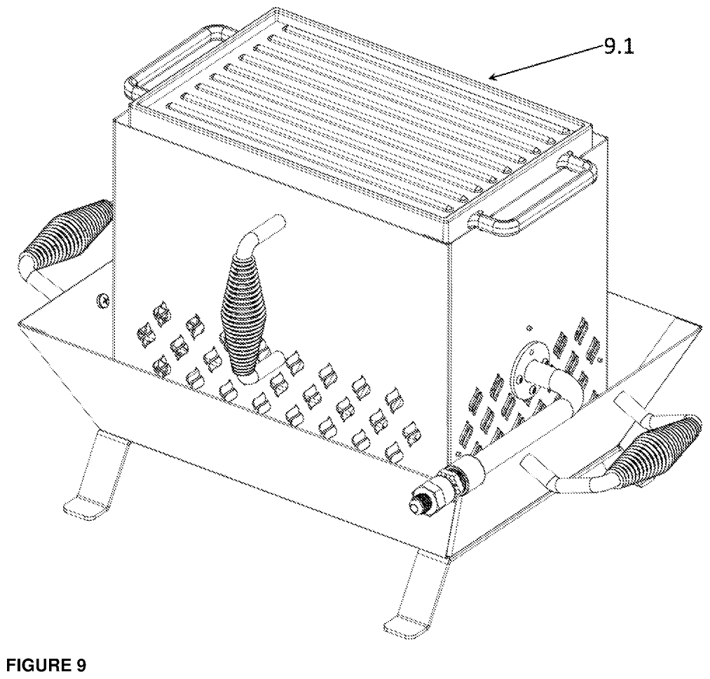

FIG. 9 of the invention is an isometric view of the Assembled High Temperature Grill Assembly with the Griddle Top in place. The Griddle Top provides a unique searing surface for foods that are better seared on a flat hot surface. The Grilling Top Handles of the Griddle Top (9.2) seat into the Coal Box through notches in the top edge of the Coal Box. This provides safety and security for the griddle top. The griddle top seats in the Coal Box with an air gap around the circumference of the Griddle Top to ensure airflow that ensures the chimney effect and the effects of extreme high temperatures.

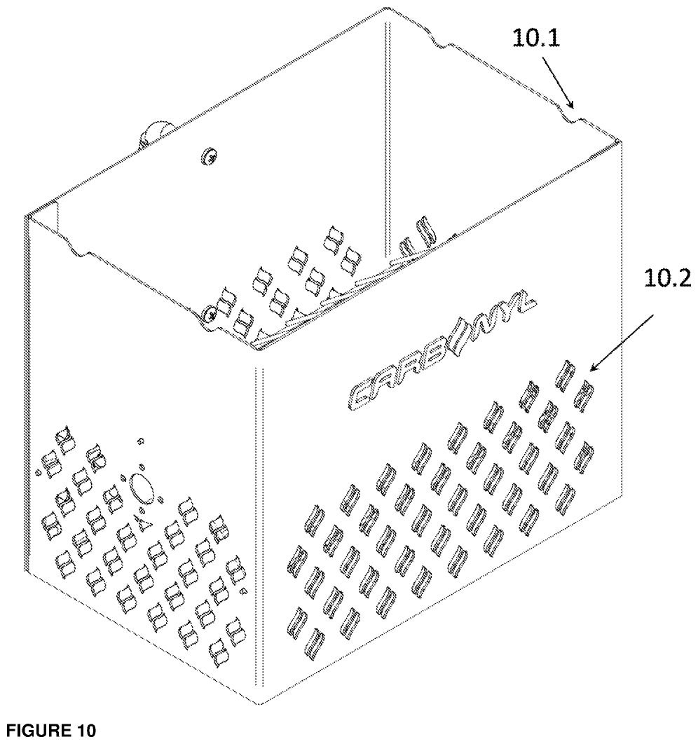

FIG. 10 of the invention is an isometric view of the High Temperature Grill Assembly Coal Box component by itself. The notches (10.1) for seating the Grill Top and Griddle top are unique to this invention. The Coal Box has a series of vent holes (10.2) to provide airflow to the solid fuel and create an intense heating effect on the Grill Top.

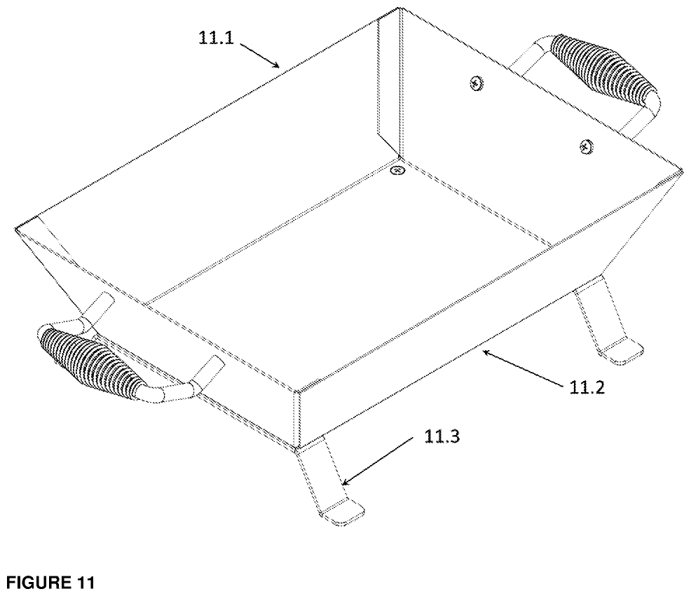

FIG. 11 of the invention is an isometric view of the High Temperature Grill Base Assembly component by itself. The side surfaces (11.1) of the Base Assembly are angled to provide sufficient airflow to the Coal Box vent holes but also provide a mechanism to maintain sparks, falling ashes and any solid fuel coals. The legs (11.3) of the Base Assembly are angled outwards and rounded to provide stability for the entire High Temperature Grill Assembly but also not mar the surface the High Temperature Grill Assembly is placed upon. The Base Assembly Handles (11.2) are secured to the Base Assembly by machine screws to provide longevity and security.

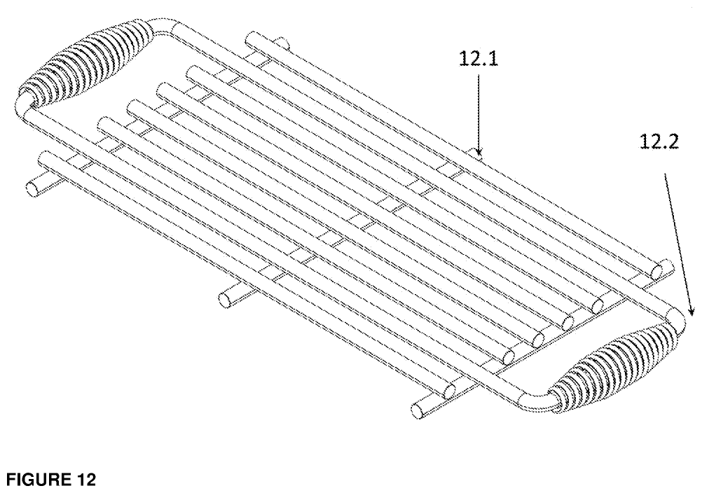

FIG. 12 of the invention is an isometric view of the High Temperature Grill Assembly Grill Top Component by itself. The horizontal metal bars (12.1) of the Grill Top fits inside the High Temperature Grill Assembly Coal Box, attach to the parallel metal bars and prevent the Grill Top from sliding off the High Temperature Grill Assembly causing a safety problem. The Grilling Top Handles (12.2) are looped around and fastened (welded) to create a single rectangular loop with handle springs that maintain a cool to the touch surface. This allows for the user to remove the grill top as needed for display, cleaning or swap out with the Griddle Top.

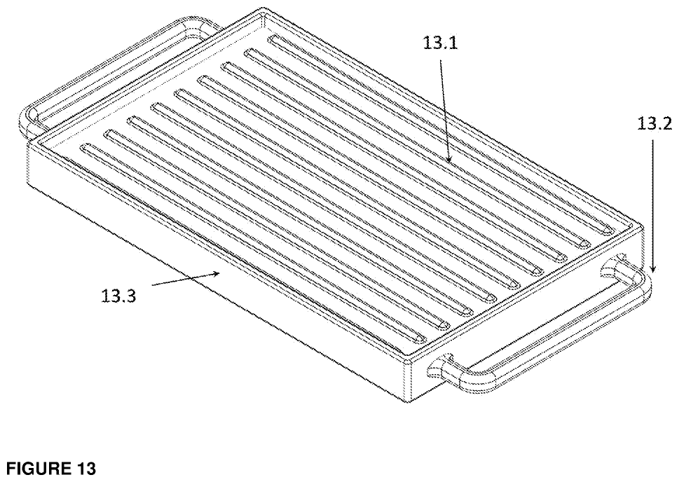

FIG. 13 of the invention is an isometric view of the Top side of the High Temperature Grill Assembly Griddle Top Component by itself. The Griddle Top has two sides and provide a user the unique ability to sear food that is not appropriate for the Grill Top. The Griddle Top can be swapped out with the Grill Top simply by removing it and seating the Griddle Top. The top side has a series of ridges (13.1) that a user can use to simulate “grill marks”. The Griddle Top handles (13.2) uniquely seat into the Coal Box in the top edge notches providing lateral and longitudinal stability and security. The Griddle Top edge (13.3) has a small, raised edge to prevent any rendered fats or added seasonings (butter, etc.) from draining out of the Griddle Top.

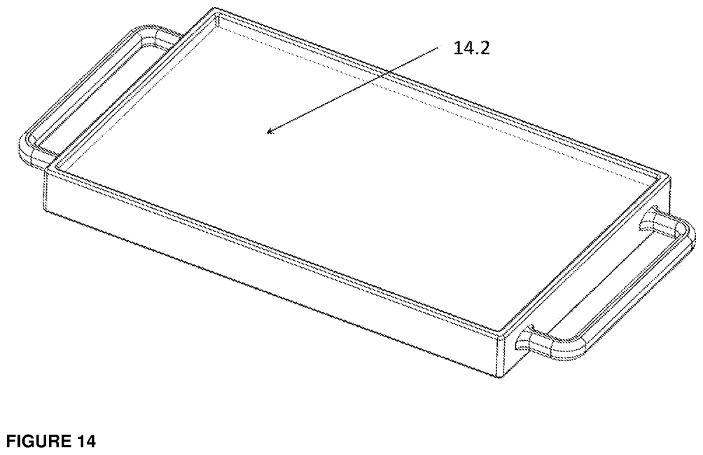

FIG. 14 of the invention is an isometric view of the Bottom side of the High Temperature Grill Assembly Griddle Component by itself. This is the reverse side of the side shown in FIG. 13. This side of the Griddle Top has a flat surface (14.2) for searing foods that require a flat surface.

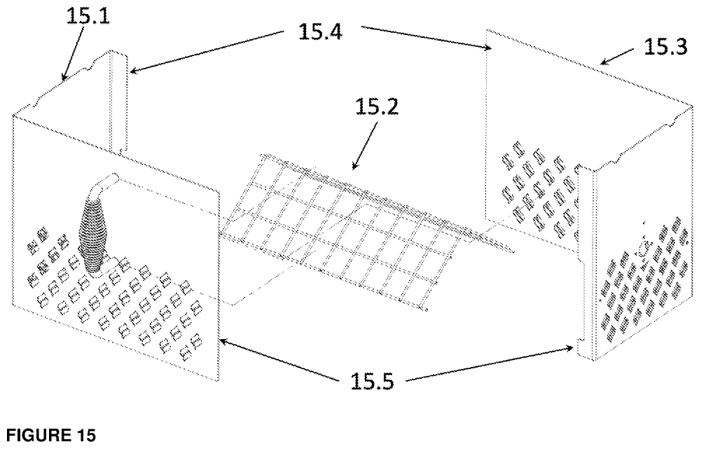

FIG. 15 of the invention is an isometric view of the Coal Box as it will be manufactured. 15.1 is the left side of the Coal Box. 15.3 is the opposing side. The Internal Grate (15.2) will be inserted into the Coal Box during final assembly. Components 15.1 and 15.3 will be spot welded together along the tabbed edges at 15.4 and 15.5.

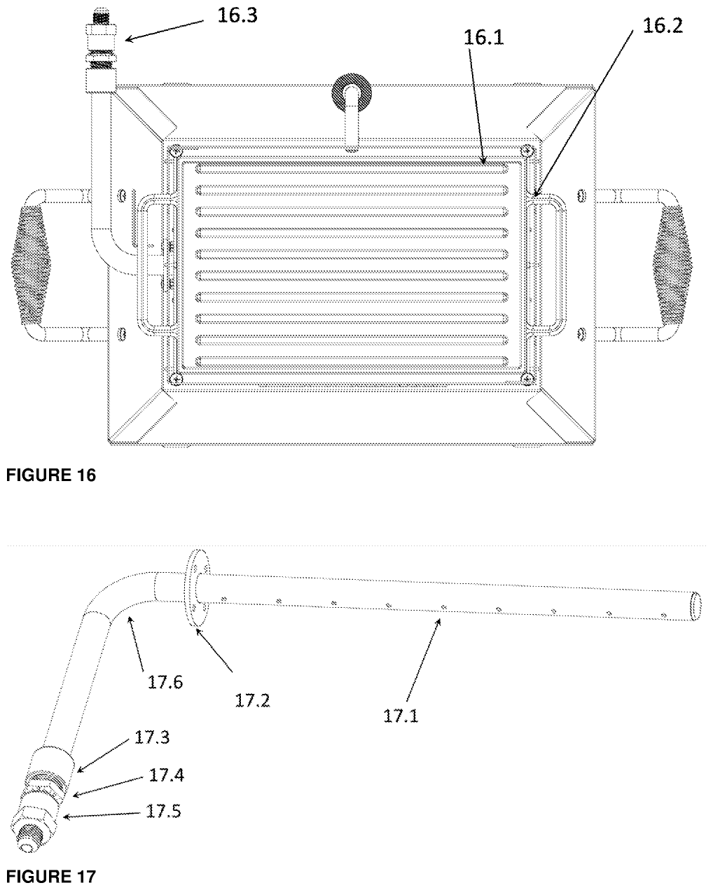

FIG. 16 of the invention is a top view of the High Temperature Grill Assembly with the Griddle Top affixed in the top of the Coal Box in such a way that there is an opening between the Coal Box walls and the edges of the Griddle Top (16.1). This opening is an innovation to allow the updraft airflow to continue unimpeded by the Griddle Top thus continuing the high temperature burning of the charcoal. The Griddle Top handle (16.2) are designed to secure the Griddle Top laterally and longitudinally in the Coal Box so that it does present a safety hazard. The Burner Tube (16.3) is designed with an angle to allow use of the Base Assembly handles and extend past the edge of the Base Assembly and far enough from the Coal Box to provide safety from excessive heat.

FIG. 17 of the invention is an Isometric view of Burner Tube separated from the Coal Box. The Burner Tube assembly has burner holes (17.1) uniquely situated on both sides of the burner tube to provide an even flame distribution on the charcoal briquettes that will be situated above the Burner Tube Assembly when it is affixed in the Coal Box. The Burner Tube has a weld attached flange (17.2) that is used to affix it to the exterior wall of the Coal Box. The Burner Tube has a unique bend (17.6) allowing it to extend past the coal box but avoid interfering with the handles of the Base (16.3). The Burner Tube has an integrated assembly for connecting to standard consumer propane tank fixtures including a welded on half threaded coupling (17.3), a threaded brass propane/air mixture valve (17.4) and a threaded NPT to Flare adapter (17.5).

The advances of the present invention include, without limitation, the following:

Integrated System—the uniqueness of the invention is a design is that it is integrated and designed as a dedicated high temperature grill assembly including all the components designed as a working product including Grill Top, Griddle Top, Coal Box, Burner Tube and Base Assembly.

Portability—the High Temperature Grill Assembly invention is easy and safe to transport. The design utilizes a series of uniquely designed handles and legs to provide a secure, stable, safe platform.

Food searing quality—the High Temperature Grill Assembly invention is designed to create the heating temperatures necessary for the best possible sear and generally are in the 800 degrees Fahrenheit to 1100 degrees Fahrenheit range.

Flexible Cooking Options—the design has a unique solution allowing an interchangeable Grill Top and Griddle Top that is unparalleled in the market.

Food searing speed and efficiently—the High Temperature Grill Assembly invention is designed to sear food quickly while using cost effective and efficient fuel.

Design Durability and Aesthetics—the High Temperature Grill Assembly Invention is designed to withstand high temperatures and with a high-quality design aesthetic.

1. A charcoal grill assembly comprising:
a base assembly comprising:
a bottom surface;
four side surfaces, each of the four side surfaces being angled outwards;
four legs extending downward from the bottom surface;
two base assembly handles extending from two of the four side surfaces;
a coal box comprising:
four side walls;
a plurality of vent holes configured on the four side walls;
a coal box handle;
a grill top;
a griddle top;
a burner tube comprising:
an angled section of tube;
a non-angled section or tube;
a tube cap configured on the angled section of tube;
a plurality of holes configured along the length of the angled section of tube;
a threaded coupling configured on the non-angled section of tube; and
a circular flange,
wherein the tube cap seals the angled section of tube,
and wherein a plurality of solid fuel briquettes are configured within the base assembly,
and wherein the coal box is configured within the base assembly such that some of the plurality of solid fuel briquettes are configured within the coal box,
and wherein the grill top and the griddle top are each interchangeably configured on top of the coal box.

2. The charcoal grill assembly of claim 1, wherein the coal box further comprises two notches configured on each of two of the four side walls.

3. The charcoal grill assembly of claim 1, wherein the coal box further comprises a plurality of air vents.

4. The charcoal grill assembly of claim 1, wherein the grill top comprises two grilling top handles, and wherein the griddle top comprises two griddle top handles,
and wherein the grill top and the griddle top are each interchangeably configured on top of the coal box by configuring the grilling top handles/griddle top handles of each the grill top and the griddle top within the notches of the coal box.

5. The charcoal grill assembly of claim 1, wherein each of the grilling top handles comprises a grilling top handle grip, and wherein each of the griddle top handles comprises a griddle top handle grip.

6. The charcoal grill assembly of claim 1, further comprising an internal grate, wherein the internal grate is configured within the coal box, and wherein the plurality of solid fuel briquettes are configured on top of the internal grate.

7. The charcoal grill assembly of claim 1, wherein the circular flange of the burner tube is coupled to the coal box such that burner tube is coupled to the coal box below the plurality of solid fuel briquettes,
and wherein the threaded coupling of the burner tube is coupled to a gas fuel source,
and wherein the burner tube uses the gas fuel source to ignite the plurality of solid fuel briquettes.

8. The charcoal grill assembly of claim 1, wherein igniting the plurality of solid fuel briquettes creates ash, and wherein the ash is collected within the base assembly.

9. The charcoal grill assembly of claim 1, wherein each of the two base assembly handles comprise a base assembly handle grip.

10. The charcoal grill assembly of claim 1, wherein the coal box further comprises two formed sheets,
and wherein each of the two formed sheets comprises two of the four side walls,
and wherein the two formed sheets are mated together to form the coal box.
